(19) United States
(12) Patent Application Publication
(10) Pub. No.: US 2025/0001374 A1
(43) Pub. Date: Jan. 2, 2025

(54) DYNAMIC DRINKING SYSTEM

(71) Applicant: THE COCA-COLA COMPANY, Atlanta, GA (US)

(72) Inventors: Brad Ernest MUNOZ, Mableton, GA (US); Raymond SCHACHT, Apopka, GA (US); Juan Carlos MOTAMAYOR, Miami, FL (US); Andrew Robert POTTER, Stapleford Cambridgeshire (GB); Jack MCKEON, Cambridge Cambridgeshire (GB); Antonia Catherine SMITH, Saffron Walden Essex (GB); Mate SPENGER, Chicksands Bedfordshire (GB); Charles KILBY, Neots Cambridgeshire (GB); Barry DOBSON, Didsbury (GB); William RUDAN, Ithaca, NY (US)

(21) Appl. No.: 18/697,877

(22) PCT Filed: Oct. 11, 2022
(86) PCT No.: PCT/US2022/046238

§ 371 Date: Apr. 2, 2024

Related U.S. Application Data
(60) Provisional application No. 63/254,312, filed on Oct. 11, 2021.

(51) Int. Cl. B01F 33/84; A47G 19/22; B01F 35/21; B01F 35/22; B01F 35/71; B01F 101/14; H04Q 9/00

(52) U.S. Cl. CPC B01F 33/8442; A47G 19/2272; B01F 35/21112; B01F 35/2112; B01F 35/2133; B01F 35/2205; B01F 35/7176; B01F 2101/14; H04Q 9/00

(57) ABSTRACT

A drinking vessel includes a fluid reservoir for containing a first fluid, a first tube extending from the fluid reservoir to an outlet at a distal end of the first tube and configured to carry the first fluid to the outlet responsive to the user drinking from the drinking vessel, a mixing chamber positioned along the first tube between the fluid reservoir and the outlet, one or more pumps fluidly coupled with the mixing chamber and configured to dispense one or more additives into the mixing chamber to be mixed with the first fluid, an airflow sensor configured to detect that the user is drinking from the drinking vessel, and a controller configured to activate at least one of the one or more pumps according to a selected dosing profile responsive to detecting that the user is drinking from the vessel.

### CROSS-REFERENCE TO RELATED APPLICATIONS

This application claims priority to and the benefit of U.S. Provisional Patent Application No. 63/254,312, filed Oct. 11, 2021, which is incorporated herein by reference in its entirety.

### BACKGROUND

The present disclosure relates generally to personal drinking systems, and more specifically to a portable drinking vessel (i.e., beverage containers). Traditional drinking vessels (e.g., bottles, flasks, cans, etc.) often contain only a single type and/or flavor of beverage that provides a static drinking experience to a user. In other words, in many bottled and dispensed beverages, the first sip will taste the same as the last. Modern consumers, however, may appreciate a more personalized drinking experience that allows them to customize their beverage with different flavors, vitamins, minerals, etc.

### SUMMARY

One implementation of the present disclosure is a drinking vessel including a fluid reservoir for containing a first fluid, a first tube extending from the fluid reservoir to an outlet at a distal end of the first tube, the first tube configured to carry the first fluid to the outlet responsive to the user drinking from the drinking vessel, a mixing chamber positioned along the first tube between the fluid reservoir and the outlet, one or more pumps fluidly coupled with the mixing chamber and configured to dispense one or more additives into the mixing chamber to be mixed with the first fluid, an airflow sensor configured to detect that the user is drinking from the drinking vessel, and a controller communicably coupled with the air sensor and the one or more pumps, the controller configured to activate at least one of the one or more pumps according to a selected dosing profile responsive to detecting that the user is drinking from the vessel.

In some embodiments, the drinking vessel further includes a wireless communications interface, the selected dosing profile received via the wireless communications interface from a user device of the user.

In some embodiments, the drinking vessel further includes one or more replaceable cartridges each containing at least one of the one or more additives, and the one or more pumps are configured to transfer the one or more additives from the one or more replaceable cartridges to the mixing chamber.

In some embodiments, the controller is further configured to determine a fill level of each of the one or more replaceable cartridges and transmit an indication of the fill level of each of the one or more replaceable cartridges to a user device of the user.

In some embodiments, the one or more pumps are selected from a group of pumps consisting of a syringe pump, a peristaltic pump, and a controlled gear pump.

In some embodiments, the drinking vessel further includes a user interface configured to display at least one of a type of the one or more additives, a fill level of one or more cartridges containing the one or more additives, and indications of error states.

In some embodiments, the drinking vessel further includes at least one of a conductivity sensor or a color sensor positioned between the mixing chamber and the outlet of the first tube, the controller further configured to determine, based on data from the least one of the conductivity sensor or the color sensor, a composition of the first fluid after mixing, the composition indicative of the amount of the one or more additives mixed with the first fluid and continuously adjust the amount of the one or more additives dispensed into the mixing chamber further based on the composition of the first fluid after mixing.

In some embodiments, the one or more additives include at least one of flavor concentrates, sweeteners, acids, vitamins, probiotics, minerals, electrolytes, fiber, amino acids, protein, dairy products, coffee concentrates, tea concentrates, juice concentrates, alcohol, pharmaceuticals, or supplements.

Another implementation of the present disclosure is a method of enhancing a fluid with additives in a portable drinking vessel including receiving, by a processor, a user selection of at least one additive to add to the fluid, detecting, by the processor, that a user is drinking from the portable drinking vessel based on first data from a first sensor, and the fluid is transferred from a main fluid reservoir to an outlet responsive to the user drinking from the portable drinking vessel, and causing, by the processor, one or more fluid transfer devices to dispense the at least one additive into a mixing chamber to mix with the fluid, the mixing chamber positioned between the main fluid reservoir and the outlet.

In some embodiments, the method further includes determining, by the processor, an amount of the at least one additive mixed with the fluid based on second data from a second sensor, comparing, by the processor, the amount of the at least one additive mixed with the fluid to determine whether the amount of the at least one additive meets a threshold associated with the user input, and initiating an automated response process responsive to determining that the amount of the at least one additive mixed with the fluid does not meet the threshold.

In some embodiments, the automated response process comprises at least one of presenting, by the processor and via a user interface, an alert indicating that the amount of the at least one additive mixed with the fluid does not meet the threshold or automatically adjusting the amount of the at least one additive dispensed into the mixing chamber.

In some embodiments, the second sensor is at least one of a conductivity sensor or a color sensor positioned between the mixing chamber and the outlet.

In some embodiments, the first sensor is an airflow sensor.

In some embodiments, the user selection is determined from a dosing profile, the dosing profile received from a user device associated with the user and comprising a plurality of different additive ratios.

In some embodiments, the one or more fluid transfer devices are pumps are selected from a group of pumps consisting of a syringe pump, a peristaltic pump, and a controlled gear pump.

In some embodiments, the one or more fluid transfer devices are configured to transfer the at least one additive from one or more replaceable cartridges to the mixing chamber.

In some embodiments, the method further includes determining, by the processor, a fill level of each of the one or more replaceable cartridges and transmitting, by the processor, an indication of the fill level of each of the one or more replaceable cartridges to a user device of the user.

In some embodiments, the method further includes displaying, by the processor and via a user interface positioned on the portable drinking vessel, at least one of a type of the at least one additive, a fill level of one or more cartridges containing the at least one additive, and indications of error states.

In some embodiments, the at least one additive includes at least one of flavor concentrates, sweeteners, acids, vitamins, probiotics, minerals, electrolytes, fiber, amino acids, protein, dairy products, coffee concentrates, tea concentrates, juice concentrates, alcohol, pharmaceuticals, or supplements.

### BRIEF DESCRIPTION OF THE DRAWINGS

Various objects, aspects, features, and advantages of the disclosure will become more apparent and better understood by referring to the detailed description taken in conjunction with the accompanying drawings, in which like reference characters identify corresponding elements throughout. In the drawings, like reference numbers generally indicate identical, functionally similar, and/or structurally similar elements.

FIG. 1 is a block diagram of a dynamic drinking system, according to some embodiments.

FIG. 2 is a block diagram of the dynamic drinking system of FIG. 1 shown with additional details, according to some embodiments.

FIG. 3 is a block diagram of a controller for the dynamic drinking system of FIG. 1, according to some embodiments.

FIG. 4 illustrates example dosing profiles for dynamically modifying characteristics of a fluid consumed by a user, according to some embodiments.

FIG. 5 is a flow diagram of a process for dynamically modifying characteristics of a fluid consumed by a user, according to some embodiments.

FIGS. 6A and 6B illustrate a drinking vessel that includes the dynamic drinking system of FIG. 1, according to some embodiments.

FIG. 7 is a diagram illustrating internal components of the drinking vessel of FIGS. 6A and 6B, according to some embodiments.

FIG. 8 is an example interface for selecting additives and/or defining an additive playlist, according to some embodiments.

FIG. 9 is an example interface for notifying a user that an additive selection and/or a playlist has been successfully implemented, according to some embodiments.

### DETAILED DESCRIPTION

Referring generally to the FIGURES, a dynamic drinking system shown, according to some embodiments. In particular, the dynamic drinking system can include a portable drinking vessel for holding a base fluid (e.g., tap water) and a plurality of additives, such as flavor, vitamins, minerals, etc. The dynamic drinking system may be configured to detect when a user is drinking from the portable drinking vessel and may dispense one or more of the plurality of additives accordingly. To provide additional customization and to provide a more intuitive user experience, the dynamic drinking system may be communicably coupled to a device associated with the user (e.g., a smartphone or tablet), thereby allowing the user to track data such as consumption, additive levels, fill level, etc., as well as to select specific additives or combinations of additives at any time.

In some cases, a user may provide a dosing profile or “playlist” that dynamically adjusts the user's drinking experience over time. For example, the user may select a single additive or set of additives that are provided continuously as the user drinks from the vessel. Additionally, additives may be changed or cycled over time to provide a dynamic drinking experience. In a “loop mode,” for example, additives may be changed in a predefined pattern every sip. For convenience and easy-of-use, the user may be able to select additives and/or define dosing profiles via a user interface, which may be provided directly on the portable drinking vessel and/or via an application on a computing device (e.g., a smartphone application). Additional features and advantages of the dynamic drinking system will be discussed in greater detail below.

### Dynamic Drinking System

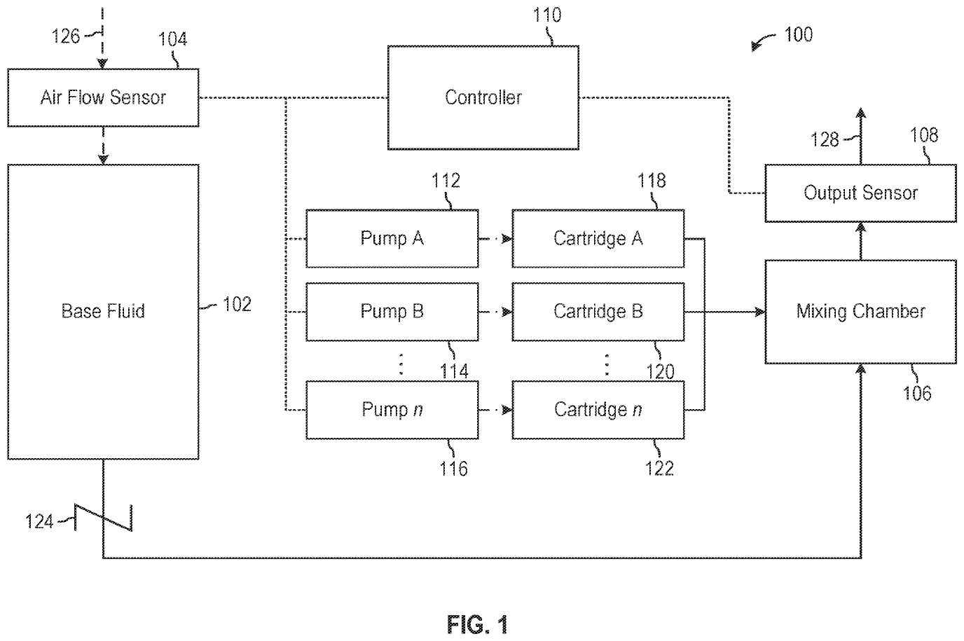

Turning first to FIG. 1, a block diagram of a dynamic drinking system 100 is shown, according to some embodiments. As mentioned above, system 100 may automatically and dynamically enhance a base fluid (e.g., water, juice, milk, etc.), which is stored (i.e., contained) in a base fluid container 102, with one or more additives. As described herein, “additives” may refer to any substance that can be mixed with a base fluid to produce an output fluid mixture. Additives may include, but are not limited to, flavor concentrate, sweeteners, acids, vitamins, probiotics, minerals, electrolytes, fiber, amino acids, protein, dairy products (e.g., milk, cream, etc.), coffee concentrates, tea concentrates, juice concentrates, alcohol, pharmaceuticals, supplements, and the like. In some embodiments, the additives are in a form to ensure adequate incorporation into the base fluid (e.g., liquid, gel, solution, suspension, colloid, etc.). Additives may be soluble or non-soluble. Base fluid container 102 may be a container configured to hold any amount (e.g., 12 oz., 16 oz., 24 oz., 32 oz., etc.) of base fluid, such as tap water, sparkling water, coffee, milk, tea, juice, etc. For example, base fluid container 102 may be formed from stainless steel, a food-grade plastic, or other suitable material and, in some embodiments, may be sealed to prevent contamination. In some such embodiments, base fluid container 102 can include a removable lid with a gasket or other material for forming an air-tight seal.

In operation, a user may drink from system 100 by creating suction (i.e., pulling a vacuum) on an outlet 128 (e.g., a straw or tube) of system 100. More specifically, the user may take one or more sips when drinking from system 100. A “sip,” as discussed herein, may be an individual bolus of fluid caused by suction from a user. For example, a drink that lasts only a few seconds may be considered a sip and/or a sip may be defined as the period between when the user creates suction and releases suction on outlet 128. A series of one or more sips while the user maintains a vacuum on outlet 128 may be considered a “drinking session.”

System 100 may include a straw, positioned after an output sensor 108, that the user drinks from. The act of drinking through the outlet portion of system 100 may cause air to flow into base fluid container 102, such as through an inlet 126 (e.g., an inlet tube). As shown, system 100 may include an air flow sensor 104 configured to detect the flow of air into base fluid container 102. In some embodiments, air flow sensor 104 is configured simply to detect air flow, indicating that a user is drinking from system 100. For example, air flow sensor 104 may detect fluctuations in air flow from a zero or local minimum value, which indicate that the user is drinking (i.e., taking a sip). In some embodiments, air flow sensor 104 may be configured to detect an amount and/or speed of the air passing into base fluid container 102. For example, air flow sensor 104 may be configured to detect whether the user is taking a slow or small sip, or whether the user is drinking quickly. In various embodiments, the air flow sensor 104 may be a positive displacement flow sensor, a mass flow sensor (e.g., thermal mass flow sensor, Coriolis flow meter, etc.), or a velocity flow sensor (e.g., mechanical flow sensor, turbine, propeller, paddle wheel, electromagnetic flow sensor, ultrasonic flow sensor, etc.). It may be beneficial to determine the amount of fluid and/or the speed that the user is consuming to ensure that a proper amount of additive is provided.

System 100 can include a controller 110 configured to receive and/or analyze data from air flow sensor 104. For example, controller 110 may receive analog and/or digital signals from air flow sensor 104 to detect air flow into the base fluid container 102 when a user is drinking, an amount or volume of fluid the user is drinking, and/or a speed at which the user is drinking. Subsequently, controller 110 can make decisions regarding the amount of one or more additives to dispense based on the detected air flow. To dispense said additives, controller 110 may provide control signals to one or more pumps, shown as pumps 112-116. Each of pumps 112-116 may be configured to dispense at least one additive. In some embodiments, the additives are stored in cartridges 118-122, which may be refillable and/or replaceable. As shown, for example, pump 112 (“Pump A”) may be configured to dispense an additive from cartridge 118 (“Cartridge A”) and pump 114 (“Pump B”) may be configured to dispense an additive from cartridge 120 (“Cartridge B”). It will be appreciated that system 100 can, accordingly, include any number of pumps and/or cartridges for dispensing additives.

As mentioned above, each of cartridges 118-122 may include at least one additive (e.g., in the form of a liquid, gel, etc.) which can be transferred to a mixing chamber 106 by a corresponding one of pumps 112-116. Specifically, additives may be transferred to mixing chamber 106 to mix with a base fluid provided by base fluid container 102. Accordingly, controller 110 may be configured to actuate pumps 112-116, thereby dispending said additives, responsive to detecting that the user is drinking, to avoid dispensing additives into mixing chamber 106 unnecessarily. In some embodiments, the movement of the base fluid through mixing chamber 106 is sufficient to cause the additive(s) and the base fluid to mix. In other embodiments, mixing chamber 106 includes additional components (e.g., baffles, static mixer, mixing devices, etc.) to cause the base fluid and additives to mix.

In some embodiments, additives are dispensed based on a selection from a user (e.g., of a single or multiple additives) and/or based on a dosing profile selected by or defined by the user. A dosing profile may indicate an amount of the one or more additives to dispense and, in some embodiments, may define a pattern for dispensing the one or more additives, as described in greater detail below. As an example, a base fluid may be enhanced with mineral, vitamin, or pharmaceutical additives, which may be beneficial for users that may otherwise have trouble receiving supplements and/or medications. In another example, a base fluid such as coffee may be enhanced with sweeteners, flavorings, creamers, etc. In yet another example, a base fluid (e.g., tap water) may be enhanced with flavors, sweeteners, and the like. Accordingly, those of ordinary skill in the art will appreciate that system 100 may accommodate any suitable base fluid and additives, and that the base fluids and additives described herein are merely examples that are not intended to be limiting.

In some embodiments, output sensor 108 (e.g., positioned after mixing chamber 106) is configured to evaluate the mixture of base fluid and additives. More specifically, output sensor 108 may be configured to detect an amount of additive(s) mixed with the base fluid and/or a ratio of additive(s) and base fluid. For example, output sensor 108 may be a conductivity sensor or an optical sensor for evaluating the output fluid mixture. Thus, controller 110 may receive data from output sensor 108 to evaluate the output fluid mixture and to make adjustments to the amount of the one or more additives being dispensed, accordingly. For example, controller 110 may be configured to increase or decrease (e.g., by providing control signals to pumps 112-116) an amount of the one or more additives being dispensed to meet an expected amount or ratio for the output fluid mixture. However, in some embodiments, controller 110 is configured to estimate the amount of additive and/or the ratio of base fluid to additive without output sensor 108. For example, controller 110 may determine an amount of each additive dispensed based on known parameters of pumps 112-116, such as transfer rate, cycle rate or cycle counts, current consumption, power consumption, etc. In various implementations, the output sensor 108 may not be present.

In some embodiments, system 100 includes a check valve 124 for controlling the flow of base fluid to mixing chamber 106. Specifically, check valve 124 may be configured to prevent the flow of base fluid and/or additives back into base fluid container 102. In some embodiments, check valve 124 may be a proportional valve or other, similar component that can be manually or automatically adjusted to manipulate the flow rate of base fluid. In some embodiments, although not explicitly shown in FIG. 1, check valve 124 may be electronically controlled by controller 110. In such embodiments, controller 110 may provide control signals to actuate check valve 124 to increase or decrease the base fluid flow rate, which may aid in ensuring a proper mixture of base fluid and additive(s). Additionally, system 100 may include a second valve (not shown) for allowing air into the system after base fluid container 102. However, in various implementations, check valve 124 and/or any additional valves may not be present.

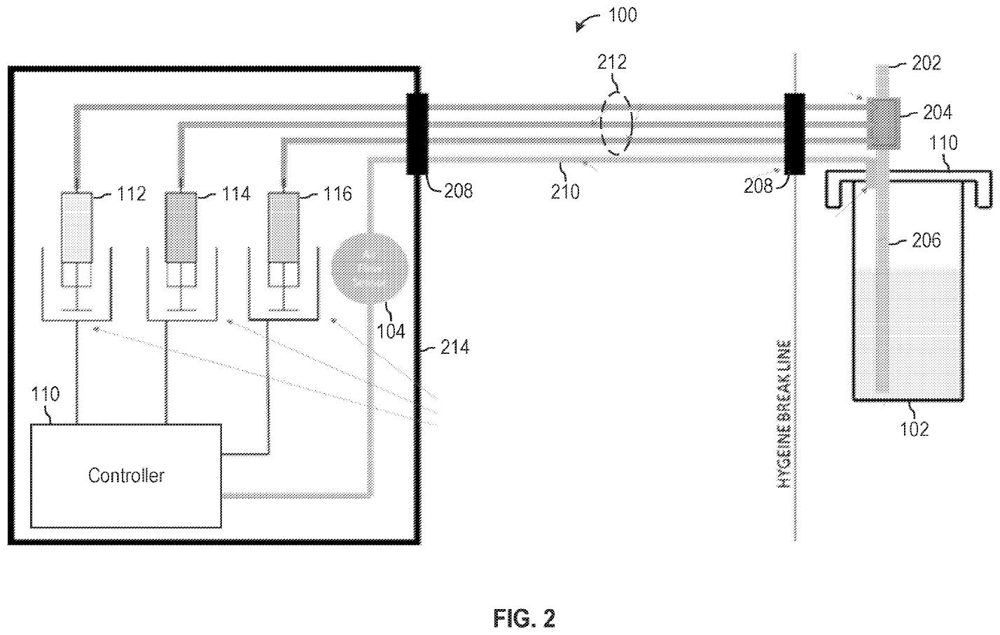

Referring now to FIG. 2, a block diagram system 100 is shown in greater detail, according to some embodiments. Specifically, the configuration of system 100 shown in FIG. 2 includes an outlet tube 202 positioned after a mixing chamber 204. Outlet tube 202 may be, for example, a straw that can be used by a user to drink from system 100. In some embodiments, outlet tube 202 is fluidly coupled to a pickup tube 206, which extends into base fluid container 102, such that base fluid can be transferred from base fluid container 102 to outlet tube 202. In some such embodiments, outlet tube 202 and pickup tube 206 are portions of the same component (e.g., a straw), which may be interrupted by mixing chamber 204. In other embodiments, outlet tube 202 and pickup tube 206 are separated components connected by mixing chamber 204. For example, the outlet tube 202 and pickup tube 206 may be removably connected to the mixing chamber 204, such as by being screwed onto, press fit, or otherwise removably connected to the mixing chamber 204, to allow for cleaning of the outlet tube 202 and pickup tube 206. Additionally, providing a removable outlet tube 202 and pickup tube 206 allows for access and cleaning of the mixing chamber 204.

A plurality of fluid conduits 212 are shown to fluidly couple each of pumps 112-116 to mixing chamber 204. Each of fluid conduits 212 may be a section of tubing or other material that allows additive to be transferred from pumps 112-116 to mixing chamber 204, for example. Additionally, an air conduit 210 is shown to extend into a lid of base fluid container 102. In some embodiments, air conduit 210 and/or fluid conduits 212 may be coupled to a housing 214 of system 100 and/or may be separated from output tube 202, mixing chamber 204, and/or base fluid container 102 via connectors 208. As shown, for example, air conduit 210 and/or fluid conduits 212 may be separated from output tube 202, mixing chamber 204, and/or base fluid container 102 at a hygiene break line. In some embodiments, fluid conduits 212 are coupled to mixing chamber 204 via a series of duckbill valves, or other suitable check valves, to prevent base fluid to mixing chamber 204 from entering fluid conduits 212 as well as to prevent dispensing or carry over of additives from the fluid conduits 212.

In the example shown, pumps 112-116 are represented as syringe pumps (i.e., syringe drivers) that actuate corresponding syringes (e.g., each containing an additive) to force the additive(s) through fluid conduits 212 to mixing chamber 204. In this manner, each syringe may be easily replaced when empty or near empty. However, it will be appreciated that pumps 112-116 may be any type of device that is capable of transferring fluid from a replaceable cartridge to mixing chamber 204. For example, pumps 112-116 may also be peristaltic pumps, controlled gear pumps, roller pumps, diaphragm pumps, or the like. Accordingly, while generally referred to herein as additive “cartridges,” additives may be stored in and dispensed from any suitable container. For example, additives may be stored in compressible cartridges, pouches, or sleeves that are squeezed by pumps 112-116 to dispense additives. As described above, pumps 112-116 may be actuated or otherwise controlled by controller 110. Additionally, controller 110 may receive data from air flow sensor 104 to determine when a user is drinking from system 100.

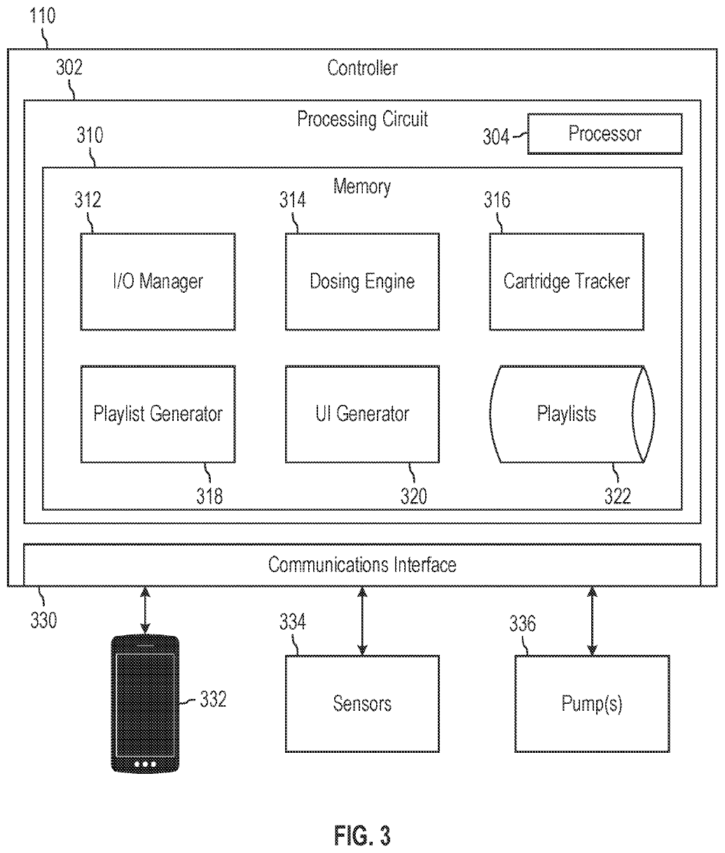

Referring now to FIG. 3, a block diagram of controller 110 is shown in greater detail, according to some embodiments. As described above, controller 110 may be configured to detect when a user is drinking from system 100 and, in response, to dispense a controlled amount of one or more additives into a mixing chamber to mix with a base fluid. Additionally, controller 110 may be configured to track fill levels of the additives and/or base fluid and can automatically and dynamically adjust a user's drinking experience by changing the types and/or amounts of additives dispensed according to dosing profiles or “playlists.”

Controller 110 is shown to include a processing circuit 302 that includes a processor 304 and a memory 310. Processor 304 can be a general-purpose processor, an application specific integrated circuit (ASIC), one or more field programmable gate arrays (FPGAs), a group of processing components, or other suitable electronic processing components. In some embodiments, processor 304 is configured to execute program code stored on memory 310 to cause controller 110 to perform one or more operations. Memory 310 can include one or more devices (e.g., memory units, memory devices, storage devices, etc.) for storing data and/or computer code for completing and/or facilitating the various processes described in the present disclosure.

In some embodiments, memory 310 includes tangible, computer-readable media that stores code or instructions executable by processor 304. Tangible, computer-readable media refers to any media that is capable of providing data that causes the controller 110 (i.e., a machine) to operate in a particular fashion. Example tangible, computer-readable media may include, but is not limited to, volatile media, non-volatile media, removable media and non-removable media implemented in any method or technology for storage of information such as computer readable instructions, data structures, program modules or other data. Accordingly, memory 310 can include random access memory (RAM), read-only memory (ROM), hard drive storage, temporary storage, non-volatile memory, flash memory, optical memory, or any other suitable memory for storing software objects and/or computer instructions. Memory 310 can include database components, object code components, script components, or any other type of information structure for supporting the various activities and information structures described in the present disclosure. Memory 310 can be communicably connected to processor 304, such as via processing circuit 302, and can include computer code for executing (e.g., by processor 304) one or more processes described herein.

While shown as individual components, it will be appreciated that processor 304 and/or memory 310 can be implemented using a variety of different types and quantities of processors and memory. For example, processor 304 may represent a single processing device or multiple processing devices. Similarly, memory 310 may represent a single memory device or multiple memory devices. Additionally, in some embodiments, controller 110 may be implemented within a single computing device (e.g., one server, one housing, etc.). In other embodiments controller 110 may be distributed across multiple servers or computers (e.g., that can exist in distributed locations). For example, controller 110 may include multiple distributed computing devices (e.g., multiple processors and/or memory devices) in communication with each other that collaborate to perform operations. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. For example, virtualization software may be employed by controller 110 to provide the functionality of a number of servers that is not directly bound to the number of computers in controller 110.

Memory 310 is shown to include an input/output (I/O) manager 312 configured to receive and transmit data and other control signals. In some embodiments, I/O manager 312 is configured to receive data from a user device 332, which is described in greater detail below. As an example, user device 332 may be a smartphone or tablet operated by a user or may be a separate user interface for allowing the user to interact with controller 110, and thereby system 100. In some embodiments, such as when user device 332 is a computing device having at least one processor and memory, user device 332 may be configured to run a software application related to system 100. Accordingly, I/O manager 312 may receive data from user device 332 based on user inputs to a user interface (e.g., displayed by the software application). For example, I/O manager 312 may receive a user selection of a particular additive or an amount of additive to mix with a base fluid (e.g., water).

In some embodiments, I/O manager 312 may also receive and/or analyze data from one or more sensors 334 and/or pump(s) 336. For example, I/O manager 312 may receive and interpret sensor data, which may be used to affect operations of controller 110. In another example, I/O manager 312 may receive operating data for pump(s) 336 to ensure that each pump is operating correctly, or to infer other operating data points, such as an amount of additive(s) dispensed, power consumption, current consumption, pump cycle rate or cycle counts, etc. Additionally, I/O manager 312 may be configured to transmit control signals to pump(s) 336 in order to affect an operation of the pumps. For example, I/O manager 312 may transmit control signals that cause a separate motor controller (e.g., for one or more of pump(s) 336) to adjust operations (e.g., speed, power, cycle rate, etc.) or I/O manager 312 may adjust an additive dispensing rate directly to pump(s) 336 to affect operations. I/O manager 312 may lower the voltage or current provided to pump(s) 336 to reduce the rate at which additives are dispensed (e.g., by slowing rotation or movement of a pump's motor or change the cycle rate of the pump), for example. In some embodiments, system 100 can include a plurality of electronically controlled valves, rather than pump(s) 336, for dispensing additives. In such embodiments, additives may be stored in compressed cartridges such that the electronic valves may be controlled (e.g., opened and closed) by controller 110 to dispense additive. For example, the cartridges may be pressurized using a gas, a spring, or by another means such that, when an electronic valve is opened, the contained additive is dispensed.

Memory 310 is also shown to include a dosing engine 314 configured to determine an amount of one or more additives to dispense. In some embodiments, dosing engine 314 may determine an amount of additive(s) based on a user input, such as a selection of a particular additive or multiple additives. For example, a user may select a flavor additive (e.g., “cherry”), such a via an application running on their smartphone, and dosing engine 314 may determine an amount of the flavor additive to dispense based on various known parameters, such as concentration of the additive, intensity level (e.g., selected by the user), base fluid properties (e.g., tap water, sparking water, etc.), etc. In some embodiments, dosing engine 314 may communicate with I/O manager 312 to transmit control signals to pump(s) 336 accordingly.

In some embodiments, dosing engine 314 can determine the amount of additive(s) based on a dosing profile, also referred to herein as a “playlist.” A dosing profile may define parameters for a single additive (e.g., type, strength, etc.) or may define parameters for multiple additives. For example, a basic dosing profile may indicate a single additive or group of additives that are dispensed continuously as a user drinks. In some embodiments, dosing profiles are based on multiple additives or cycles of additives. For example, a dosing profile may define a cycle of additives that are automatically dispensed over time. In this example, each additive or set of additives may be dispensed for a predefined period before dosing engine 314 switches to the next additive or set of additives.

In some embodiments, dosing is determine based on stored dosing profiles, shown as playlists 322. A user may configure playlists 322, such as via user device 332, and may also be able to retrieve stored playlists 322 for use or modification. In some embodiments, playlists 322 may be received from external sources, such as an online database. For example, users may be able to generate unique playlists 322 that can be shared with other users (e.g., via an online website or directly). Dosing engine 314 can, accordingly, retrieve stored playlists 322 at any time.

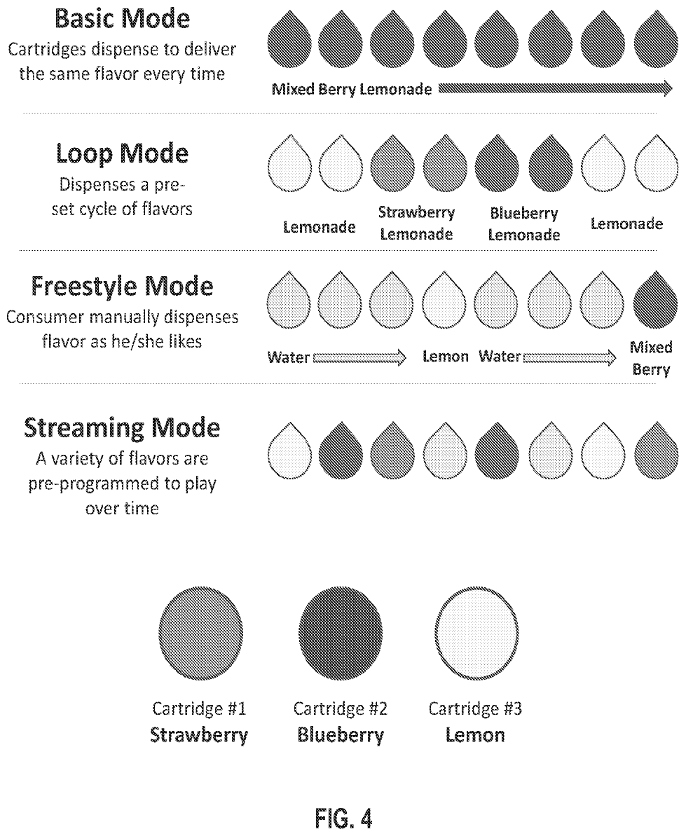

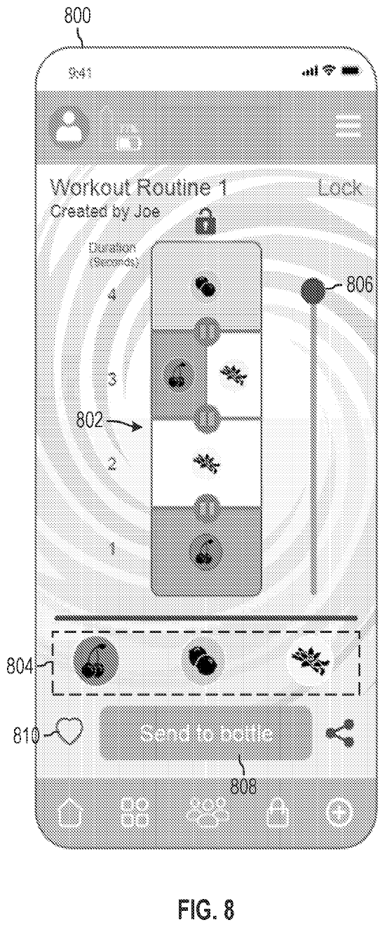

With additional reference to FIG. 4, example additive playlists (i.e., dosing profiles) are shown, according to some embodiments. As described above, playlists may be predefined and/or created and customized by users. For example, a user may define a playlist via a corresponding smartphone application, as discussed below in with respect to FIG. 8. A basic playlist may include only a single additive combination that is dispensed continuously (i.e., with each sip) over time. In the example shown, each sip may be represented by a droplet. Accordingly, in the example “basic mode,” each sip that the user takes will be flavored with a mixed berry lemonade additive, which may be a single additive or which may be created from multiple additives (e.g., berry flavoring plus lemonade flavoring).

In a more advanced “loop mode,” a predefined cycle of different additives may be dispensed, such as with each sip or based on an amount of time. In this example, the base fluid may be enhanced with lemonade flavor for two sips, then may be enhanced with strawberry lemonade flavor for the next two sips (e.g., strawberry flavor plus lemonade flavor). Additionally, or alternatively, additives may be cycled at a time interval (e.g., every minute, every hour, etc.).

In a “freestyle mode,” a user may select additives manually (e.g., in real-time), which are only dispensed during the current sip, or until the user switches additives or elects not to include an additive. For example, the user may select to add lemon flavoring only for a particular sip, as shown. Finally, in a “streaming mode,” a variety of additives may be predefined to dispense over time, such as with each sip or at predetermined time intervals. In this example, system 100 cycles, with each sip, from lemonade, to mixed berry lemonade, to strawberry, and back to plain base fluid (e.g., water). Accordingly, a “streaming mode” may be designed to correspond to real-world events such as a user's workout, a song, a television program, etc.

In some embodiments, dosing engine 314 is also configured to monitor an output fluid mixture (e.g., a mixture of a base fluid and one or more additives) for quality assurance. Specifically, dosing engine 314 may be configured to determine an amount of additive mixed with the base fluid to determine a composition of the base fluid (e.g., a ratio of base fluid to additive) and/or to determine an actual amount of additive dispensed. In some embodiments, dosing engine 314 receives data from an output sensor configured to analyze the output fluid mixture. For example, the color or total dissolved solids (TDS) of the output fluid mixture may be measured to evaluate the mixture. In other embodiments, dosing engine 314 can determine parameters of the output fluid mixture based on other measurements or known data, such as the rate at which pump(s) 336 transfer fluid. In particular, pump(s) 336 may transfer fluid at a known rate (e.g., based on applied power, current, cycle rate, etc.); thus, dosing engine 314 may infer the output fluid mixture based on the dispensing rate of pump(s) 336 to dispense the one or more additives.

Memory 310 is also shown to include a cartridge tracker 316 configured to track the usage and/or fill level of the one or more additive cartridges. In some embodiments, cartridge tracker 316 may determine the fill level of each additive cartridge based on sensor data, such as from sensors 334 or other sensors that are included in the additive cartridges. In other embodiments, cartridge tracker 316 may monitor or track cartridge fill levels over time, based on a known starting capacity and by tracking the amount of additive dispensed over time based on pump data, such as from pumps 336. For example, cartridge tracker 316 may determine the total amount of each additive dispensed over time, which can be subtracted from the initial fill capacity to estimate the current fill level. In some such embodiments, a fill level of each additive cartridge may be known (i.e., predefined) at the time the cartridge is installed.

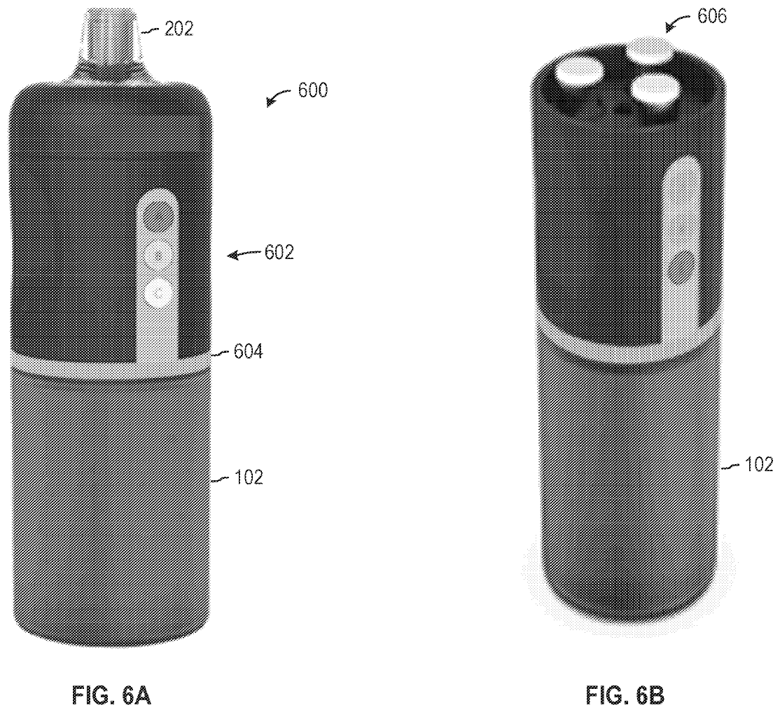

Memory 310 is also shown to include a user interface (UI) generator 320 configured to generate any of the graphical user interfaces described herein. In some embodiments, UI generator 320 is configured to generate a user interface that allows a user to establish dosing profiles, as described above and as shown in detail in FIG. 8. UI generator 320 may also present a user with an option to select individual additives, to select predefined dosing profiles, to share dosing profiles, and more. In some embodiments, the user interfaces generated by UI generator 320 are presented via a user device, such as user device 332 described below. UI generator 320 may cause user device 332 to display a user interface on a screen, for example. In some embodiments, system 100 may include a separate and/or built-in user interface (e.g., as shown in FIGS. 6A and 6B) that can be controlled by UI generator 320. For example, UI generator 320 can cause the user interface to display images, graphics, etc., and may also manipulate indicator lights (e.g., LEDs) or other components (e.g., speakers) to relay information to a user.

Still referring to FIG. 3, controller 110 is also shown to include a communications interface 330. Communications interface 330 may facilitate communications between controller and any external components or devices. For example, communications interface 330 can provide means for transmitting data to, or receiving data from, one or more sensors 334 and pump(s) 336. Accordingly, communications interface 330 can be or can include a wired or wireless communications interface (e.g., jacks, antennas, transmitters, receivers, transceivers, wire terminals, etc.) for conducting data communications. In some embodiments, communications interface 330 may also provide power to various external components. For example, controller 110 may power sensors 334 via communications interface 330.

In various embodiments, communications via communications interface 330 may be direct (e.g., local wired or wireless communications) or via a network (e.g., a WAN, the Internet, a cellular network, etc.). For example, communications interface 330 can include a WiFi transceiver for communicating via a wireless communications network. In another example, communications interface 330 may include cellular or mobile phone communications transceivers. In yet another example, communications interface 330 may include a low-power or short-range wireless transceiver (e.g., Bluetooth®).

In some embodiments, sensors 334 include at least an air flow sensor, such as air flow sensor 104 configured to detect the flow rate of air entering system 100, and more specifically air entering base fluid container 102, as described above. In some embodiments, sensors 334 can also include a conductivity and/or color (i.e., photoelectric) sensor for evaluating the color and/or composition of an output fluid mixture. For example, a color sensor may be used to determine a color of the output fluid mixture, to determine whether an appropriate amount of one or more additives is present. Sensors 334 can also include any number of other suitable sensors for providing information relating to the various operations of system 100. For example, sensors 334 can include position/motion sensors for detecting when a user is drinking (e.g., when the user tips the drinking vessel) and/or fill level sensors for detecting a fill level of the one or more additive cartridges and/or the base fluid container.

Pump(s) 336, which can be the same as or similar to any of pumps 112-116 described above, can include any device suitable for transferring additives (e.g., in the form of liquid, gel, solution, suspension, colloid, etc.) from a cartridge (e.g., a syringe, collapsible container, etc.) to a mixing chamber. For example, pump(s) 336 can include one or more syringe pumps, peristaltic pumps, roller pumps, diaphragm pumps, controlled gear pumps, etc. Pump(s) 336 may be electronically controlled by controller 110, such as by receiving control signals. For example, controller 110 may provide variable power to pump(s) 336 to control their motion. In other example, pump(s) 336 may be powered by a separate controller (e.g., a motor controller) that receives signals from controller 110. In this example, controller 110 may simply transmit data that includes instructions such as rotational speed, distance, power, etc.

In some embodiments, controller 110 is communicably coupled to user device 332 via communications interface 330 (e.g., via a wireless network). User device 332 may be a computing device including a memory (e.g., RAM, ROM, Flash memory, hard disk storage, etc.), a processor (e.g., a general-purpose processor, an application specific integrated circuit (ASIC), one or more field programmable gate arrays (FPGAs), a group of processing components, or other suitable electronic processing components), and a user interface (e.g., a touch screen), allowing a user to interact with controller 110. User device 332 can include, for example, mobile phones, electronic tablets, laptops, desktop computers, workstations, vehicle dashboards, and other types of electronic devices. More generally, user device 332 may include any electronic device that allows a user to interact with controller 110, and more broadly with system 100, by presenting and/or receiving user inputs through a user interface. In some embodiments, user device 332 represents a user interface positioned on system 100 itself, as described below with respect to FIGS. 6A and 6B. In some embodiments, user device 332 is configured to execute (i.e., run) a software application that presents the various user interfaces described herein.

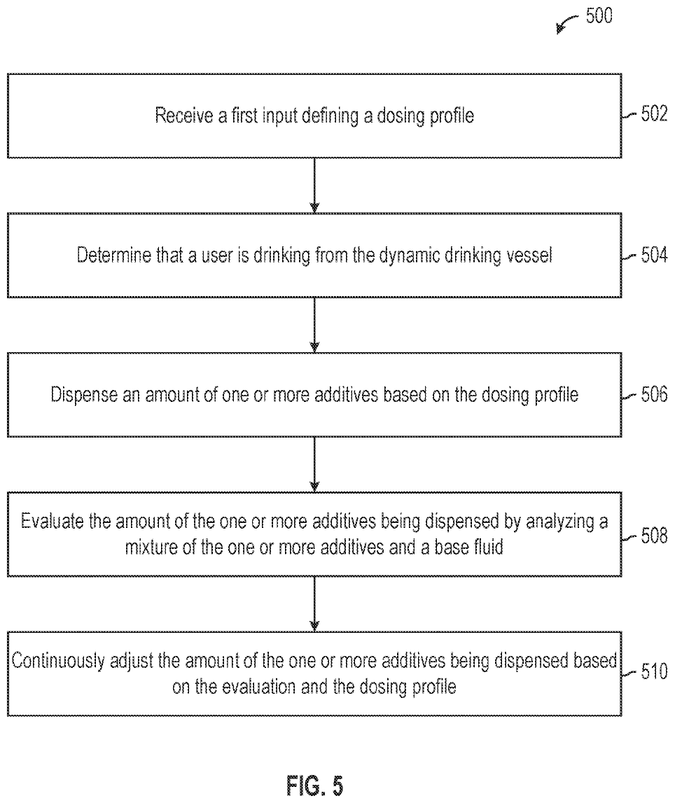

Referring now to FIG. 5, a flow diagram of a process 500 for dynamically modifying characteristics of a fluid consumed by a user is shown, according to some embodiments. As briefly described above, process 500 may improve a user's drinking experience by automatically and dynamically enhancing a base fluid or beverage (e.g., water, coffee, etc.) with one or more additives. Additionally, unlike other methods that may only allow a user to select a single additive, process 500 adjust additives over time based on user inputs and/or a selected additive playlist. In some embodiments, process 500 is implemented by controller 110, as described above. It will be appreciated that certain steps of process 500 may be optional and, in some embodiments, process 500 may be implemented using less than all of the steps.

At step 502, a first input that defines a dosing profile is received. As described above, a dosing profile or additive playlist indicates an amount of the one or more additives to dispense and, in some cases, may define a pattern for dispensing the one or more additives at regular intervals (e.g., every sip, every second, etc.). In some embodiments, the first input is a user input provided to a user interface. For example, a user may define the dosing profile on a user device, such as a smartphone running a software application. In some such embodiments, the user may select particular additives and/or intervals for switching between additives. For example, the user may select only a single additive that is dispensed with each sip, or the user may define a playlist that changes additives over time.

At step 504, a determination is made indicating that the user is drinking from the dynamic drinking vessel (e.g., system 100). In other words, system 100 detects that the user is drinking. In some embodiments, an air flow sensor is used to measure the flow of air into a base fluid container, which can indicate that the user is drinking. For example, air may enter the base fluid container to displace the base fluid responsive to the user drinking (e.g., by creating suction on an output tube). Accordingly, the system may detect that the user is drinking based on air flow data. In other embodiments, alternative or additional sensors are used to detect drinking. For example, a motion sensing device may determine a position of the drinking vessel. In this example, it may be determined that the user is drinking from the vessel if the vessel is tipped at certain angles.

At step 506, an amount of one or more additives as dispensed based on the dosing profile. As described above, the one or more additives may be dispensed into a mixing chamber to mix with a passing base fluid (e.g., water, coffee, etc.). For example, controller 110 may send control signals to one or more pumps or electronic valves to cause the one or more additives to be dispensed from corresponding cartridges. In some embodiments, additive is dispensed from only a single cartridge at a time, while in other embodiments, multiple additives are dispensed simultaneously. In some embodiments, the amount of additive is predetermined. For example, the concentration of each additive may be known; thus, the amount of each additive to mix with a given base fluid may be know based on a dilution ratio (e.g., 3:1, 5:1, 10:1, 15:1, 50:1, 75:1; 100:1, 150:1, etc.).

At step 508, the mixture of the one or more additives and the base fluid (i.e., the output fluid mixture) is evaluated for quality assurance. In particular, the amount of additives dispensed may be determined to ensure that the amount of additive, or a ratio of additive to base fluid, falls within a predefined threshold. For example, the threshold may be a range of acceptable values that indicate that the output fluid mixture is ideal for consumption. In this regard, a value that exceeds the threshold may indicate a mixture that is too weak (i.e., diluted) or strong. In some embodiments, the output fluid mixture is evaluated by measuring a conductivity, TDS, color, or other parameter of the output fluid mixture. For example, a color (i.e., optical) sensor may evaluate the output fluid mixture to determine whether color of the mixture is acceptable. In some embodiments, the amount of additive dispensed is known based on the characteristics of the pumps or other components of system 100. For example, pump(s) 336 may transfer additive at a known rate based on input current or voltage; thus, the output fluid mixture may be evaluated by calculating an amount of additive or a ratio based on known input parameters (e.g., voltage, current, time, etc.).

At step 510, the amount of additive being dispensed is continuously adjusted based on one or both of the dosing profile and the evaluation of the output fluid mixture. For example, if the output fluid mixture is determined to be properly mixed (e.g., containing an appropriate amount of additive), then system 100 may continue following the dosing profile to adjust additives (e.g., switching to different additives, increasing or decreasing intensity, etc.). However, if there is a discrepancy with the output fluid mixture (e.g., too much or too little additive), then the amount of additives being dispensed may be adjusted. In some embodiments, an alert or error message may also be displayed (e.g., via a user interface) or transmitted to a user's device to alert the user.

Additionally, the fill level of each additive cartridge may be monitored over time to ensure adequate capacity for a selected playlist. For example, system 100 may track the fill level of each additive cartridge based on known dispensing rates and an initial fill level or may simply determine the fill level of each cartridge based on sensor data. If a cartridge is empty or near empty (e.g., if the cartridge fill level is at or below a predefined threshold), an alert may be displayed or transmitted to a user's device requesting that the corresponding cartridge be replaced. Additionally, in some embodiments, system 100 may automatically reorder cartridges responsive to cartridge fill levels. For example, when a cartridge is below a certain fill level (e.g., 40%), a replacement cartridge may automatically be ordered and shipped.

Referring now to FIGS. 6A and 6B, an example drinking vessel 600 that includes system 100 is shown, according to some embodiments. In particular, drinking vessel 600 is shown to include a body configured to house the various components of system 100 described above, including controller 110, sensors 334, and pump(s) 336. In some embodiments, the body of drinking vessel 600 is separated into two halves, including a top half for housing said components and a bottom half for containing a base fluid. In this regard, the bottom half of drinking vessel 600 may be the same as or functionally equivalent to base fluid container 102.

The body of drinking vessel 600 may be formed of any suitable material, or from multiple different materials, that are both food-safe and washable. For example, the top half of the body may be formed from aluminum and the bottom half of the body (i.e., base fluid container 102) may be formed of plastic, glass, etc. In some embodiments, the body is formed of heatproof and/or dishwasher safe materials, such that one or both halves of drinking vessel 600 may be washed in a dishwasher. However, in other cases, drinking vessel 600 may at least be designed to be handwashed (e.g., controller 110 may be housed in a waterproof enclosure). In some embodiments, as shown in FIG. 6B, the top of drinking vessel 600 (e.g., the spout and/or output tube 202) may be removable for access to one or more additive cartridges 606. In such embodiments, the top of drinking vessel 600 can be attached with threads or by a seal. Accordingly, the user may easily be able to replace any of additive cartridges 606.

Drinking vessel 600 is also shown to include a user interface 602, which may include a display screen, buttons, or the like. In the example shown, user interface 602 is a digital touchscreen display presenting reconfigurable icons, each representing a particular additive. In this manner, a user may be able to select one or more additive by touching the corresponding icon on user interface 602. In other embodiments, user interface 602 may include physical buttons that can be selected by the user. In some embodiments, user interface 602 may be configured to display additional information such as battery level, cartridge fill levels, selected additives, selected playlist, etc. Additionally, drinking vessel 600 may include an indicator 604, which may be a light or a ring of lights that can act as an additional user interface. For example, indicator 604 may be illuminated as a green light to indicate that drinking vessel 600 is operating normally, or with red light when drinking vessel 600 is malfunctioning or when a battery level is below a threshold (i.e., the battery is low). In some embodiments, indicator 604 may correspond to the one or more selected additives. For example, a color of indicator 604 may correspond to a color of an output fluid mixture based on the selected additives.

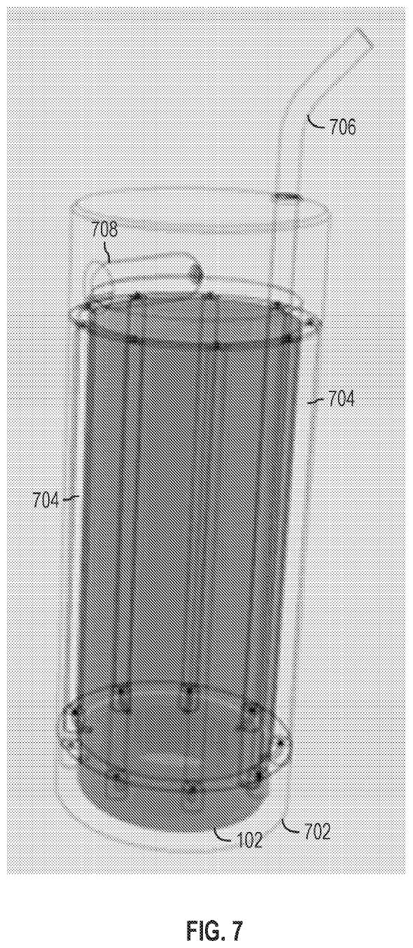

Referring now to FIG. 7, a diagram illustrating internal components of drinking vessel 600 is shown, according to some embodiments. In particular, drinking vessel 600 is shown to include a housing 702 which contains base fluid container 102. Surrounding base fluid container 102 are a plurality of additive cartridges 704. In this example, additive cartridges 704 are positioned at regular intervals around the circumference of base fluid container 102; however, it will be appreciated that the positioning of additive cartridges 704 shown in FIG. 7 is merely an example, and that any of the components shown in FIG. 7 may be positioned in any feasible manner. Also shown is a straw 706 that extends into base fluid container 102 to allow a user to drink from the vessel (e.g., by creating suction). Additionally, drinking vessel 600 may include a gas cartridge 708, such as a carbon dioxide or nitrogen cartridge, for carbonating or nitrogen-charging the base fluid. In some embodiments, gas cartridge 708 may also be used to provide pressure to one or more of additive cartridges 704. In other embodiments, the fluid of additive cartridges 704 may be compressed using a spring or other component to create pressure. Thus, in some such embodiments, additive may be dispensed by actuating electronic valves (e.g., by controller 110) rather than by driving pumps.

### User Interface

Referring now to FIG. 8, an example interface 800 for selecting additives and/or defining an additive playlist (i.e., dosing profile) is shown, according to some embodiments. In particular, interface 800 shows an example playlist titled “Workout Routine 1,” which may be created by a user and displayed by user device 332. Interface 800 is shown to include a first graphical element 802 representing the additive playlist itself. In this example, the user has defined an additive playlist separated into four distinct sections, which may correspond to seconds, sips, or another interval. Specifically, the additive playlist includes one interval of cherry flavor additive, one interval of vanilla flavor additive, one interval of lime flavor additive, and one interval of a combination of vanilla and cherry flavor additives. In some embodiments, prior to selection of the specific additives, each interval includes a blank space or empty “block” that can be selected to subsequently identify a particular additive. For example, additives may be selected from a list (e.g., based on the cartridges installed in the drinking vessel or based on all available additives) or may be selected from a menu 804 and dragged into an available block.

In some embodiments, menu 804 displays available additives for generating a playlist, such as based on the cartridges installed in the drinking vessel. In this example, cherry, lime, and vanilla flavor additives are shown. In some embodiments, a user may select one of the additives from menu 804, rather than or in addition to populating element 802, in order to dispense a single additive (e.g., “basic mode” as shown in FIG. 4). Interface 800 also includes a second graphical element 806, shown as a slider, that may be selected to move to a particular position in the playlist. Accordingly, element 806 may track the playlist during operation (e.g., as the user is drinking) to identify which portion of the playlist is active. For example, element 806 may move to the “vanilla additive” block after the user's second sip or after three seconds. Additionally, the user may be able to manually move element 806 to skip to a particular position. For example, the user may slide element 806 the “cherry additive” block to manually enhance their beverage with cherry flavoring.

After a playlist is defined and/or selected, or after a particular additive is selected, the playlist/selection may be transmitted to system 100 by selecting a “Send to Bottle” button 808. Additionally, the user may save the playlist by selecting an icon 810, shown here as a heart. In some embodiments, such as when the user retrieves a playlist from an online database or receives a playlist from another user, the user may also select icon 810 to “favorite” the playlist, which may add said playlist to a folder or menu for later selection. Interface 800 is also shown to include a second icon for sharing created playlists. For example, playlists may be shared with other uses directly or via social media or may be posted to a website or other online database.

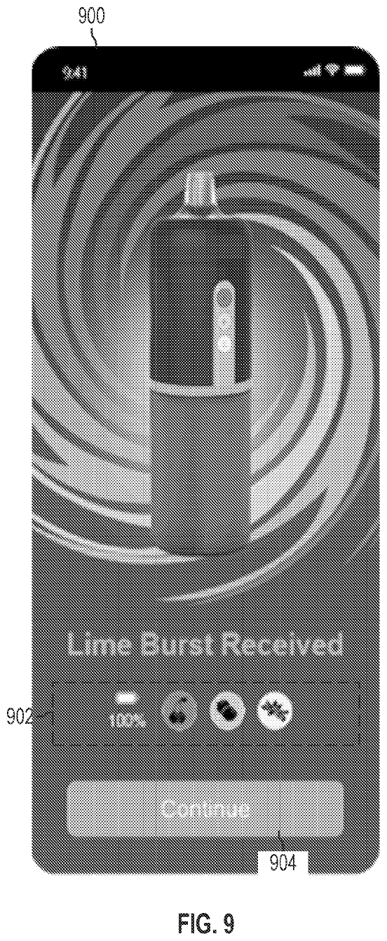

Referring now to FIG. 9, an example interface 900 for notifying a user that an additive selection and/or a playlist has been successfully implemented is shown, according to some embodiments. In some cases, interface 900 may be displayed responsive to the user selecting button 808, as described above, to send the playlist or selection to the drinking vessel. Interface 900 is shown to include a menu 902 that displays the battery level of the drinking vessel (e.g., drinking vessel 600), along with available/installed additive cartridges. In this example, the user has chosen to enhance their beverage with lime flavor additive. The user may be able to navigate back to a home screen, menu, or interface 800 by selecting a “Continue” button 904. In some embodiments, although not shown, one or both of interfaces 800 and 900 may also be configured to display error messages related to system 100. For example, an error message may be displayed when the battery of the drinking vessel is low, when a cartridge is empty or malfunctioning, or when an output fluid mixture is not within a predefined threshold (e.g., ratio, color, etc.).

### Configuration of Exemplary Embodiments

The construction and arrangement of the systems and methods as shown in the various exemplary embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements may be reversed or otherwise varied, and the nature or number of discrete elements or positions may be altered or varied. Accordingly, all such modifications are intended to be included within the scope of the present disclosure. The order or sequence of any process or method steps may be varied or re-sequenced according to alternative embodiments. Other substitutions, modifications, changes, and omissions may be made in the design, operating conditions and arrangement of the exemplary embodiments without departing from the scope of the present disclosure.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products including machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures, and which can be accessed by a general purpose or special purpose computer or other machine with a processor.

When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions include, for example, instructions and data which cause a general purpose computer, special purpose computer, or special purpose processing machines to perform a certain function or group of functions.

Although the figures show a specific order of method steps, the order of the steps may differ from what is depicted. Also, two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection steps, processing steps, comparison steps and decision steps.

1. A drinking vessel comprising:
a fluid reservoir for containing a first fluid;
a first tube extending from the fluid reservoir to an outlet at a distal end of the first tube, the first tube configured to carry the first fluid to the outlet responsive to the user drinking from the drinking vessel;
a mixing chamber positioned along the first tube between the fluid reservoir and the outlet;
one or more pumps fluidly coupled with the mixing chamber and configured to dispense one or more additives into the mixing chamber to be mixed with the first fluid;
an airflow sensor configured to detect that the user is drinking from the drinking vessel; and
a controller communicably coupled with the air sensor and the one or more pumps, the controller configured to activate at least one of the one or more pumps according to a selected dosing profile responsive to detecting that the user is drinking from the vessel.

2. The drinking vessel of claim 1, further comprising a wireless communications interface, the selected dosing profile received via the wireless communications interface from a user device of the user.

3. The drinking vessel of claim 1, further comprising one or more replaceable cartridges each containing at least one of the one or more additives, wherein the one or more pumps are configured to transfer the one or more additives from the one or more replaceable cartridges to the mixing chamber.

4. The drinking vessel of claim 3, the controller further configured to:
determine a fill level of each of the one or more replaceable cartridges; and
transmit an indication of the fill level of each of the one or more replaceable cartridges to a user device of the user.

5. The drinking vessel of claim 1, wherein the one or more pumps are selected from a group of pumps consisting of a syringe pump, a peristaltic pump, a diaphragm pump, and a controlled gear pump.

6. The drinking vessel of claim 1, further comprising a user interface configured to display at least one of a type of the one or more additives, a fill level of one or more cartridges containing the one or more additives, and indications of error states.

7. The drinking vessel of claim 1, further comprising at least one of a conductivity sensor or an optical sensor positioned between the mixing chamber and the outlet of the first tube, the controller further configured to:
determine, based on data from the least one of the conductivity sensor or the optical sensor, a composition of the first fluid after mixing, the composition indicative of the amount of the one or more additives mixed with the first fluid; and
continuously adjust the amount of the one or more additives dispensed into the mixing chamber further based on the composition of the first fluid after mixing.

8. The drinking vessel of claim 1, wherein the one or more additives include at least one of flavor concentrates, sweeteners, acids, vitamins, probiotics, minerals, electrolytes, fiber, amino acids, protein, dairy products, coffee concentrates, tea concentrates, juice concentrates, alcohol, pharmaceuticals, or supplements.

9. A method of enhancing a fluid with additives in a portable drinking vessel, the method comprising:
receiving, by a processor, a user selection of at least one additive to add to the fluid;
detecting, by the processor, that a user is drinking from the portable drinking vessel based on first data from a first sensor, wherein the fluid is transferred from a main fluid reservoir to an outlet responsive to the user drinking from the portable drinking vessel; and
causing, by the processor, one or more fluid transfer devices to dispense the at least one additive into a mixing chamber to mix with the fluid, the mixing chamber positioned between the main fluid reservoir and the outlet.

10. The method of claim 9, further comprising:
determining, by the processor, an amount of the at least one additive mixed with the fluid based on second data from a second sensor;
comparing, by the processor, the amount of the at least one additive mixed with the fluid to determine whether the amount of the at least one additive meets a threshold associated with the user input; and
initiating an automated response process responsive to determining that the amount of the at least one additive mixed with the fluid does not meet the threshold.

11. The method of claim 10, wherein the automated response process comprises at least one of:
presenting, by the processor and via a user interface, an alert indicating that the amount of the at least one additive mixed with the fluid does not meet the threshold; or
automatically adjusting the amount of the at least one additive dispensed into the mixing chamber.

12. The method of claim 10, wherein the second sensor is at least one of a conductivity sensor or an optical sensor positioned between the mixing chamber and the outlet.

13. The method of claim 9, wherein the first sensor is an airflow sensor.

14. The method of claim 9, wherein the user selection is determined from a dosing profile, the dosing profile received from a user device associated with the user and comprising a plurality of different additive ratios.

15. The method of claim 9, wherein the one or more fluid transfer devices are pumps are selected from a group of pumps consisting of a syringe pump, a peristaltic pump, a diaphragm pump, and a controlled gear pump.

16. The method of claim 9, wherein the one or more fluid transfer devices are configured to transfer the at least one additive from one or more replaceable cartridges to the mixing chamber.

17. The method of claim 16, further comprising:
determining, by the processor, a fill level of each of the one or more replaceable cartridges; and
transmitting, by the processor, an indication of the fill level of each of the one or more replaceable cartridges to a user device of the user.

18. The method of claim 9, further comprising displaying, by the processor and via a user interface positioned on the portable drinking vessel, at least one of a type of the at least one additive, a fill level of one or more cartridges containing the at least one additive, and indications of error states.

19. The method of claim 9, wherein the at least one additive includes at least one of flavor concentrates, sweeteners, acids, vitamins, probiotics, minerals, electrolytes, fiber, amino acids, protein, dairy products, coffee concentrates, tea concentrates, juice concentrates, alcohol, pharmaceuticals, or supplements.
